(19) United States
(12) Patent Application Publication
(10) Pub. No.: US 2007/0041747 A1
(43) Pub. Date: Feb. 22, 2007

(54) Image forming apparatus having vibration reducing member

(75) Inventors: Jong-tae Kim, Seoul (KR); Sung-dae Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/484,764

(22) Filed: Jul. 12, 2006

(30) Foreign Application Priority Data
Aug. 22, 2005 (KR) 10-2005-0076963

(51) Int. Cl. G03G 15/06; G03G 15/08

(52) U.S. Cl. 399/222; 399/265; 399/279

(57) ABSTRACT

An image forming apparatus having a vibration reducing member is provided. The image forming apparatus includes a photosensitive member, a developing roller, an axis of the developing roller, and a gear train for driving the developing roller. Accordingly, the quality of print image is improved by providing the vibration reducing member in which the natural frequency in the rotation direction of the developing roller is less than the exciting frequency in the direction of the developing roller.

### CROSS-REFERENCE TO RELATED PATENT APPLICATION

This application claims the benefit under 35 U.S.C §119(a) of Korean Patent Application No. 10-2005-0076963, filed on Aug. 22, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an electrophotographic image forming apparatus that reduces vibration in the rotation direction of a developing roller.

2. Description of the Related Art

Generally, electrophotographic image forming apparatuses carry out a series of printing operations in which light is illuminated onto a photosensitive member to form an electrostatic latent image corresponding to a print image. The electrostatic latent image is developed in a developing unit with a developing material. The developed toner image is fused onto a printing medium in a fixing unit by applying heat and pressure thereto.

FIG. 1 is a perspective view of a conventional photosensitive member 7 coupled to a developing unit and of a driving unit for the developing unit. Referring to the drawing, an electrostatic image is formed on the outer circumference of the photosensitive member 7. A developing roller 6, which faces the photosensitive member 7, develops the electrostatic latent image with a developing material. A driving unit drives the developing roller 6. In a non-contact jumping type developing unit, the photosensitive member 7 and the developing roller 6 are separated from each other by a predetermined development gap. Which is provided by a gap ring 5. The driving unit transfers the rotation force generated by a driving motor 1 to the developing roller 6 through a plurality of gear trains 2 and 3.

The photosensitive member 7 and the developing roller 6 must rotate at a uniform speed. When the rotation speed jitters, printing quality deteriorates. In particular, when printing an image, such as a picture or a photograph, the printing quality deterioration stemming from the jitter increases. The jitter is generated when the constant rotation speeds of photosensitive member 7 and the developing roller 6 ripple due to a shock or vibration. In particular, the shock or vibration generated inwardly in the driving unit is a cause of the jitter when the shock or the vibration is transmitted to the developing roller 6 rotating at a constant speed. At this time, the developing roller 6 instantly diverts from a predetermined path and the speed thereof. To reduce the jitter, the shock or vibration needs to be prevented from being transmitted to the developing roller 6 or to be reduced. In a conventional developing unit shown in FIG. 1, the developing roller 6 and the driving unit are rigidly engaged (see reference numerals 4A and 4B in FIG. 1), and a vibration reducing member is not provided.

Accordingly, a need exists for an image forming apparatus that substantially eliminates or reduces shocks and vibrations transferred to a developing roller.

### SUMMARY OF THE INVENTION

The present invention provides an image forming apparatus that reduces shock or vibration transferred to a developing roller to substantially prevent jitter generation and printing failure caused thereby.

According to an aspect of the present invention, an image forming apparatus includes a photosensitive member on which an electrostatic latent image is formed. A developing unit that develops the electrostatic latent image by the use of developing materials and that includes a developing roller that rotates about the rotation axis thereof, in which the developing roller faces the photo-sensitive member. A vibration reducing member reduces vibration in the rotation direction of the developing roller.

The vibration reducing member may reduce the vibration in the rotation direction of the developing roller by changing the natural frequency in the rotation direction of the developing roller to be less than the exciting frequency in the rotation direction of the developing roller.

Additionally, the vibration reducing member, which reduces the equivalent torsional elastic modulus of the developing roller, may include an elastic body provided to at least one portion of the rotation axis.

Additionally, the vibration reducing member, which reduces the equivalent torsional elastic modulus of the developing and provides damping characteristic, may include a visco-elastic body provided to at least one portion of the rotation axis.

Additionally, the developing unit may further include a gear train for transferring driving force to the rotation axis, wherein the vibration reducing member, which reduces the equivalent torsional elastic modulus of the developing roller and provides damping characteristic, may include a visco-elastic body provided at teeth of at least one gear among the gear train.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a driving unit of a conventional developing unit;

FIG. 2 is a side elevational view of an image forming apparatus according to an exemplary embodiment of the present invention;

FIG. 3 is a side elevational view of a photosensitive member and a developing unit according an exemplary embodiment of the present invention;

FIG. 4A through 4E are perspective views of a vibration reducing member provided at the rotation axis according to an exemplary embodiment of the present invention;

FIG. 5 is a side elevational view of a vibration reducing member provided at a gear train according to an exemplary embodiment of the present invention;

FIG. 6 is a perspective view of a vibration model of a driving system of a developing roller according to an exemplary embodiment of the present invention;

FIG. 7 is a graph illustrating a vibration reducing operation of the vibration reducing member according to an exemplary embodiment of the present invention; and

FIG. 8 is a graph illustrating a damping operation of the vibration reducing member according to an exemplary embodiment of the present invention.

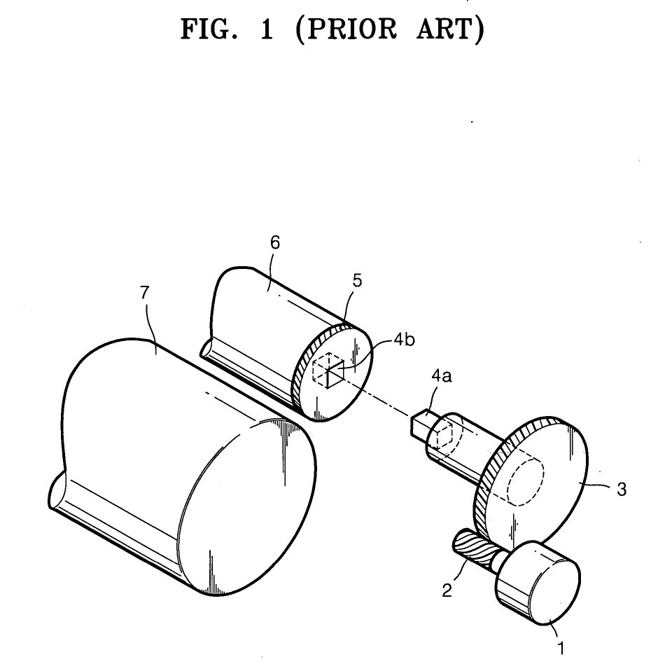

Throughout the drawings, the same drawing reference numerals will be understood to refer to the same elements, features, and structures.

### DETAILED DESCRIPTION OF EXEMPLARY EMBODIMENTS

Hereinafter, exemplary embodiments of the present invention are described in detail with reference to the accompanying drawings. The exemplary embodiments of the present invention, however, are not limited thereto but various changes in form and details may be made therein without departing from the spirit and scope of the present invention.

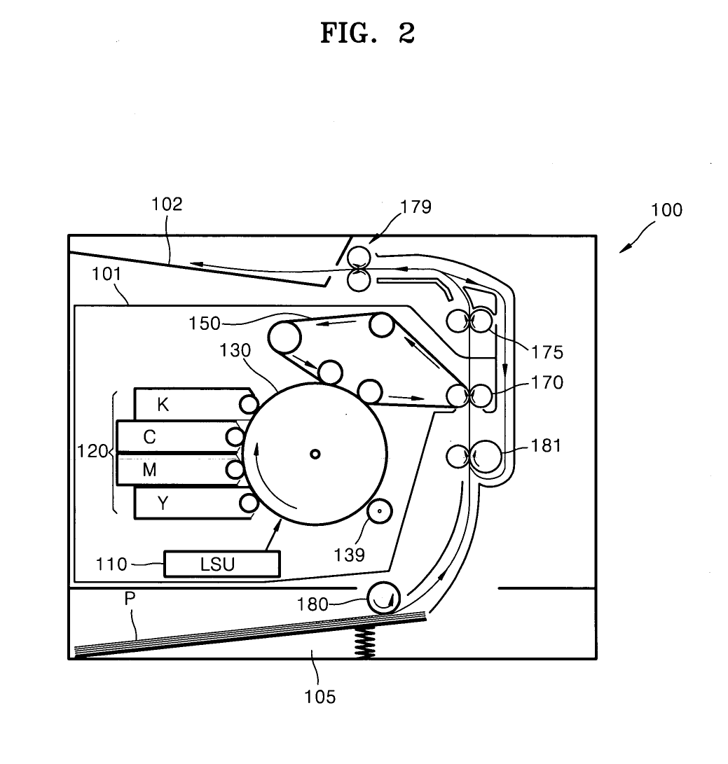

FIG. 2 is a side elevational view of an image forming apparatus 100 according to an exemplary embodiment of the present invention. Referring to the drawing, a printing unit 101 for printing an image onto a printing medium P and a fixing unit 175 for fusing the printed image onto the printing medium P are provided. The printing unit 101 includes a charging unit 139, a laser scanning unit (LSU) 110, a photosensitive member 130, a developing unit 120, an intermediate transfer belt 150, and a transfer belt 170. For color printing, the printing unit 101 provides four developing units 120 containing developing materials of black K, cyan C, magenta M, and yellow Y.

The charging unit 139 uniformly charges the surface of the photosensitive member 130. For example, the laser scanning unit 110 forms a yellow electrostatic latent image by illuminating light corresponding to image data of yellow Y onto the photosensitive member 130. A developing unit 140Y develops the electrostatic latent image to form a yellow toner image. The toner image is transferred onto the intermediate transfer belt 150. In a substantially similar manner, the toner images of magenta M, cyan C, and black K are sequentially overlapped and transferred onto the intermediate transfer belt 150, so that a complete color toner image is formed on the intermediate transfer belt 150.

The printing medium P is picked up from a loading cassette 105 by a pickup roller 180 and transferred to the area where the intermediate transfer belt 150 and the transfer roller 170 face one another by a feed roller 181. The toner image is transferred from the intermediate transfer belt 150 towards the printing medium P. The toner image transferred onto the printing medium P is fused by the use of the fixing unit 175. The fixing unit 175, which includes a pressure roller (not shown) and a heat roller (not shown), fuses the toner image onto the printing medium P by applying heat and pressure. At least one discharge roller 179 loads the printed printing medium P out of the printing unit 101. The discharged printing medium P that is stored on a paper loading tray 102 one atop another.

FIG. 2 is a view of a four-pass type color electrophotographic image forming apparatus 100 in which charging, laser scanning, and developing are respectively carried out for each of the four colors to print an image on a sheet of printing medium P and that includes the intermediate transfer belt 150, but the exemplary embodiment of the image forming apparatus of the present invention is not limited thereto. Although not shown, a black-and-white image forming apparatus includes one developing unit and one photosensitive member; a single-pass type color image forming apparatus includes four developing units and four photosensitive members; and a two-pass type image forming apparatus includes two units, where one unit is composed of two developing units and one photosensitive member.

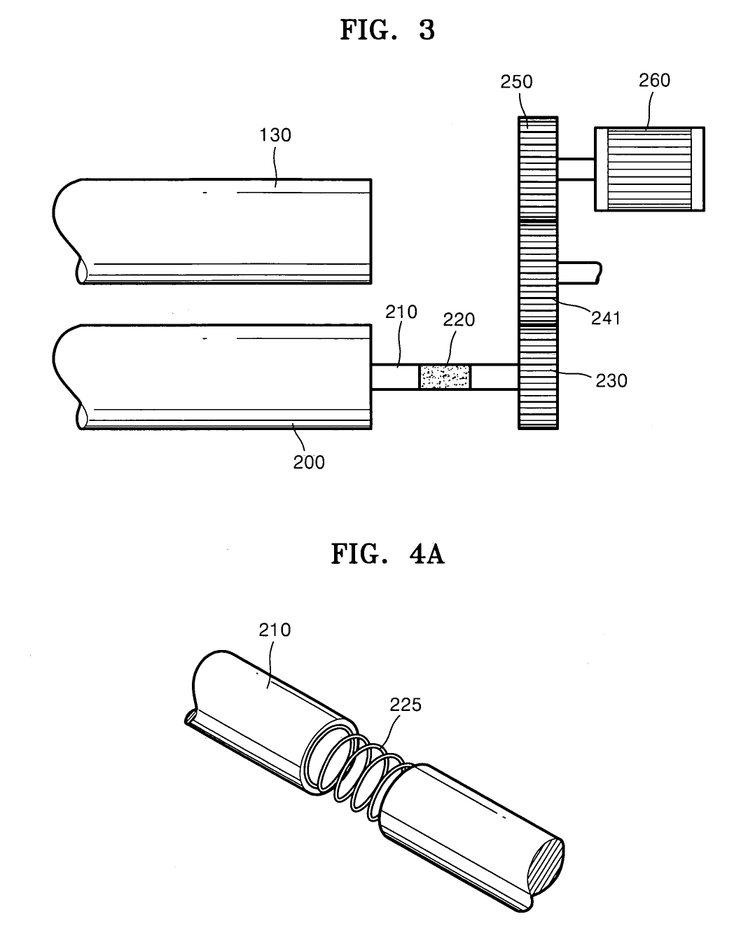

FIG. 3 is a side elevational view of the photosensitive member 130 and the developing unit 120 according to an exemplary embodiment of the present invention. Referring to the drawing, the developing unit 120 includes a developing roller 200, a rotation axis 210 provided at the rotation center of the developing roller 200, and gear train 230, 241, and 250 for transferring driving force from a driving motor 260 to the rotation axis 210. The surfaces of the developing roller 200 and the photosensitive member 130 are separated from each other, and a development gap is formed thereto. Additionally, the photosensitive member 130 and the developing roller 200 rotate at a substantially constant speed. The driving motor 260 provides driving force to the rotation axis 210 of the developing roller 200 by means of a plurality of gear trains 230, 241, and 250 for a speed reduction. When the driving motor 260, the gear train 230, 241, and 250, the rotation axis 210, and the developing roller 200 rotate, vibration occurs due to disparity of axis centers, eccentric mass, and contact shock in rotation portions. The developing roller 200 may jitter while rotating at a substantially constant speed, which can lead to a cause of printing failure.

The image forming apparatus according to an exemplary embodiment of the present invention includes a vibration reducing member. The vibration reducing member reduces vibration in the rotation direction of the developing roller 200 by changing the natural frequency in the rotation direction of the developing roller 200 to be less than the exciting frequency in the rotation direction of the developing roller 200. The shift of the natural frequency that reduces vibration is described in detail hereinafter. The vibration reducing member reduces the vibration, which has influence on jitter generation, in the rotation direction of the developing roller 200. A vibration reducing member with respect to the radial and longitudinal directions of the developing roller 200 may be readily devised based on the exemplary embodiments of the present invention.

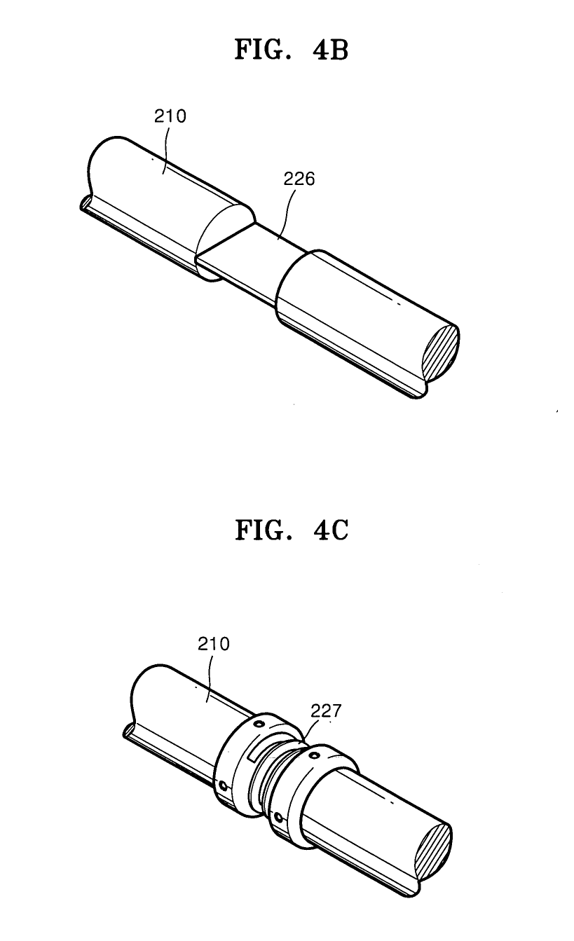

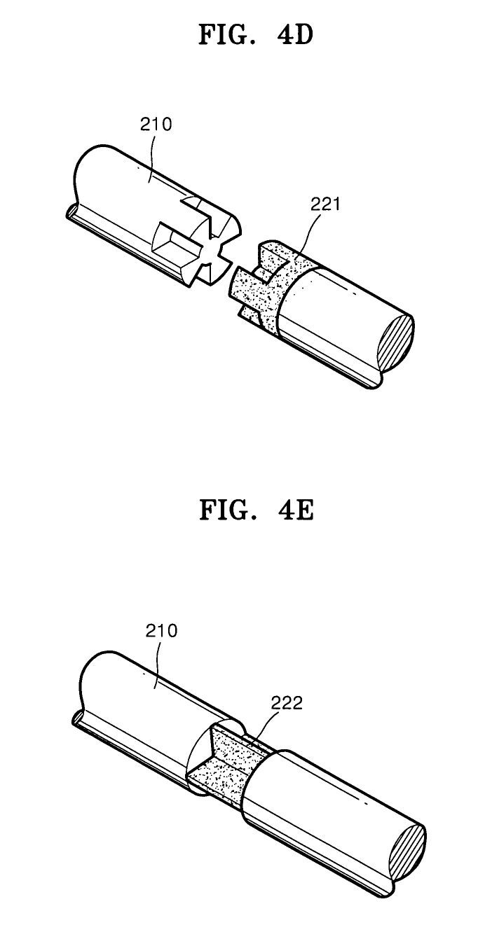

In an exemplary embodiment, the vibration reducing member, which reduces the equivalent torsional elastic modulus of the developing roller 200, includes an elastic body 220 provided to at least one portion of the rotation axis 210. The equivalent torsional elastic modulus is determined by converting the torsional elastic modulus of all rotating bodies, such as the developing roller 200, the rotation axis 210 of the developing roller, the gear train 230, 241, and 250, each of the rotation axes (not shown) of the gear train 230, 241, and 250, and the driving motor 260, into a value with respect to the developing roller 200 by taking gear reduction ratio into consideration. A detailed explanation for this is omitted because it is already well-known. The entire portion of the developing roller 200 and the rotation axis 210 may be formed as the elastic body 220 to substantially prevent the development of image deteriorating phenomena. The elastic body 220 may be a coil shape torsion spring 225 shown in FIG. 4a, which is inserted between first and second portions of the rotation axis 210, which is cut into at least two portions to connect the portions thereof; a plate shape torsion spring 226 shown in FIG. 4B; and a flexible coupling 227 shown in FIG. 4C. The flexible coupling 227, which serves to connect two axes, elastically connects two axes that are partially out of the center thereof. A detailed explanation for this is omitted because it is already well-known to those skilled in the art.

The torsional elastic modulus of the elastic body 220 needs to meet the following requirements. Namely, the natural frequency in the rotation direction of the developing roller 200 must be less than the exciting frequency in the rotation direction of the developing roller 200, so that vibration in the rotation direction of the developing roller 200 is reduced. A detailed explanation for the operation of the elastic body 220 is described hereinafter.

The vibration reducing member, which reduces the equivalent torsional elastic modulus of the developing roller 200 and provides damping characteristic, includes visco-elastic bodies 221 and 222 provided to at least one portion of the rotation axis 210, as shown in FIGS. 4D and 4E. The visco-elastic bodies 221 and 222 are made of at least one of rubber, urethane and synthetic resin. The visco-elastic bodies 221 and 222 may be made of rubber or urethane, shown in FIGS. 4D and 4E, which are inserted into first and second portions of the rotation axis 210, which is cut into at least two portions to connect the portions thereof. The torsional elastic modulus of the visco-elastic bodies 221 and 222 meet the requirement that the natural frequency in the rotation direction of the developing roller 200 is to be less than the exciting frequency thereof. The visco-elastic bodies 221 and 222 also have damping characteristics that substantially reduce the vibration in the rotation direction of the developing roller 200. A detailed explanation of the operation of the visco-elastic bodies 221 and 222 is described hereinafter. The visco-elastic bodies 221 and 222 preferably have sufficient elastic properties and damping characteristics, with the rigidity thereof being less than approximately 80 degrees.

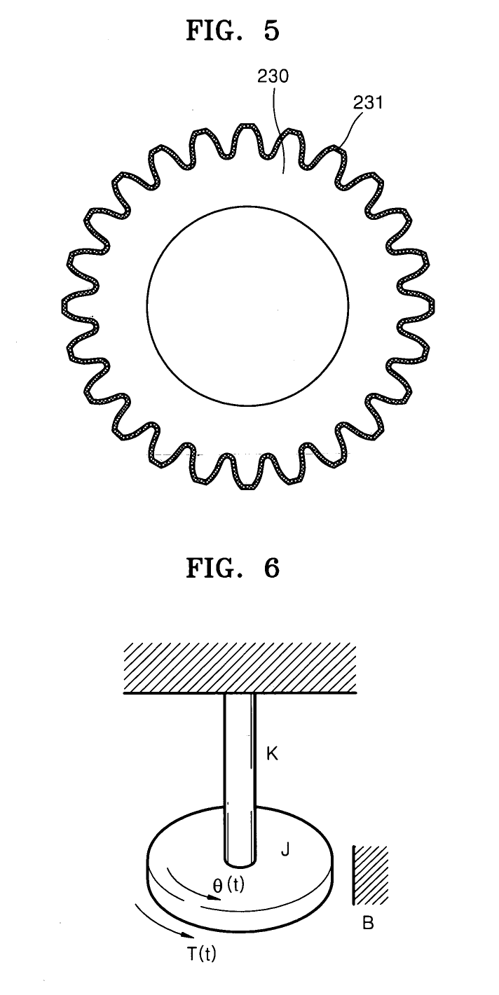

The vibration reducing member in another exemplary embodiment substantially reduces the equivalent torsional elastic modulus of the developing roller 200 and provides damping characteristics, includes a visco-elastic body 231 provided at teeth of at least one gear among the gear train 230, 241, and 250. For example, FIG. 5 illustrates a gear 230 of which the surface of the teeth is coated with rubber or urethane. Alternatively, the entire portion of the gear train 230, 241, and 250 may be made of rubber of urethane. The visco-elastic body 231 preferably has sufficient elastic properties and damping characteristics, with the rigidity thereof being less than approximately 80 degrees.

The exemplary embodiments of the vibration reducing member may be summarized as follows. First, the elastic body 220 is provided at the rotation axis 210, the visco-elastic bodies 221 and 222 are provided at the rotation axis 210, and the visco-elastic body 231 is provided to at least one gear among the gear train 230, 241, and 250. Alternatively, the elastic body 220 may be provided at the rotation axis 210 with the visco-elastic body 231 being provided to at least one gear among the gear train 230, 241, and 250. Alternatively, the visco-elastic bodies 221 and 222 may be provided at the rotation axis 210 with the visco-elastic body 231 being provided to at least one gear among the gear train 230, 241, and 250. Various combinations thereof are possible further alternative exemplary embodiments

The elastic body 220 provides a predetermined elastic property, and the visco-elastic bodies 221, 222, and 231 provide elastic properties and damping characteristics at the same time. The elastic body 220 reduces the amplitude of a transfer function by changing the natural frequency in the rotation direction of the developing roller 200. The visco-elastic bodies 221, 222, and 231 improve the damping characteristics and change the natural frequency. The elastic body 220 or the visco-elastic bodies 221, 222, and 231 reduce the vibration in the rotation direction of the developing roller 200.

FIG. 6 is a perspective view of a vibration model of a driving system of the developing roller 200. Referring to the drawing, a mass moment of inertia of all rotating bodies, a torsional elastic modulus thereof, and a damping coefficient thereof, each being converted into an equivalent value with respect to the developing roller 200, are denoted as J, K, and B, respectively. Angular displacement of the developing roller 200 is referred to as θ(t) as a function of time, and a driving torque provided to the developing roller 200 is referred to as T(t) as a function of time. The driving system of the developing roller 200 includes the developing roller 200, the driving motor 260, the gear train 230, 241, and 250, and various rotating bodies, such as each of rotation axes of the gear train 230, 241, and 250. The mass moment of inertia of all rotating bodies, the torsional elastic modulus thereof, and the damping coefficient thereof are converted into the equivalent values with respect to the developing roller 200. A more detailed description for the modeling process of the driving system of the developing roller 200 is omitted because it is readily devised by those skilled in the art. A dynamic equation for the driving system of the developing roller 200 adopting the equivalent values is expressed as follows.

$$J \frac{{ⅆ}^{2} θ ( t )}{ⅆ {t}^{2}} + B \frac{ⅆ θ ( t )}{ⅆ t} + K θ ( t ) = T ( t ) \qquad [ Equation 1 ]$$

To obtain the transfer function, the initial condition with respect to the θ(t) is set to 0, where T(t) is an input value and θ(t) is an output value. The mathematical expression 1 is then Laplace transformed to obtain the transfer function M(s) as follows.

$$( {Js}^{2} + Bs + K ) θ ( s ) = T ( s ) \\ M ( s ) = \frac{θ ( s )}{T ( s )} = \frac{1}{{Js}^{2} + Bs + K} = \frac{1}{K} ( \frac{{w}_{n}^{2}}{{s}^{2} + 2 ζ {w}_{n} s + {w}_{n}^{2}} ) \\ {w}_{n} = \sqrt{\frac{K}{J}} , \\ ζ = \frac{B}{2 \sqrt{KJ}} \qquad [ Equation 2 ]$$

Wn is natural frequency and t is damping ratio. To obtain the frequency response M(jw) with respect to the transfer function M(s), s=jw is substituted into the mathematical equation 2. For convenience, the amplitude |M(jw)| of the frequency response is normalized to remove the effect of a gain component 1/K. The amplitude |m(jw)| of the normalized frequency response is as follows.

$$\vert m ( jw ) \vert = \frac{\vert M ( jw ) \vert}{\vert M ( j 0 ) \vert} \qquad [ Equation 3 ]$$

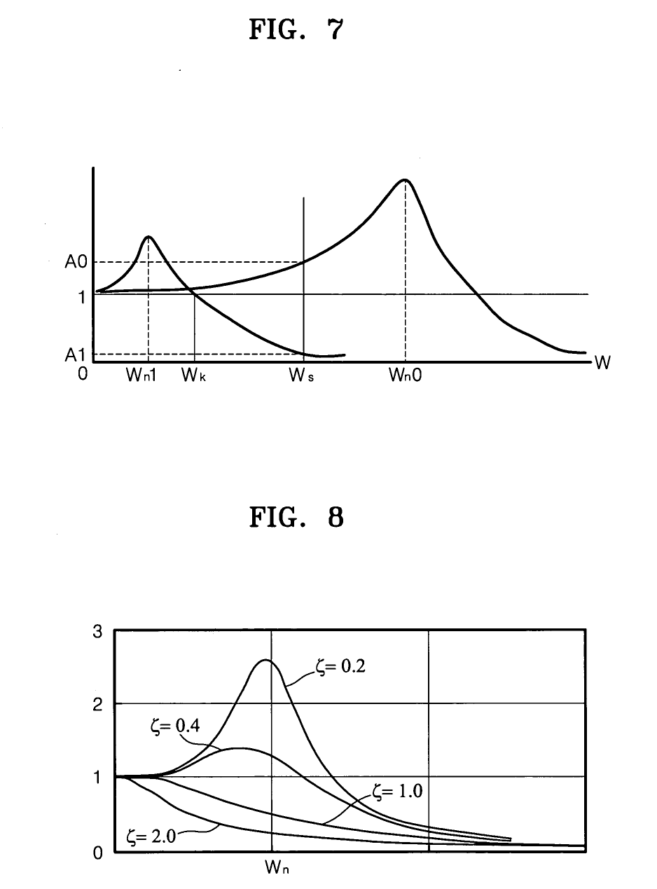

FIG. 7 is a graph illustrating a vibration reducing operation of the vibration reducing member according to the present invention. The y-axis represents the amplitude |m(jw)| of the normalized frequency response, whereas x-axis represents a frequency w. The natural frequency of the driving system of the developing roller 200 before the vibration reducing member is prepared is referenced as Wn0. Wn0 may be more than 200 Hz. After the vibration reducing member is provided in the rotation direction of the developing roller 200, the natural frequency is reduced to Wn1. The Wn1 may be approximately 20 Hz. In a system having a second order transfer function, there is a portion that the amplitude of the normalized frequency response is less than 1 in an area where the frequency thereof is higher than the natural frequency. Namely, the system having a second order transfer function may be basically seen as a low pass filter. If the amplitude of the normalized frequency response is less than 1, an output component, that is, the amount of vibration of the rotation angle of the developing roller 200, may be reduced when a rotation torque having a sinusoidal vibration component is input to the driving system of the developing roller 200. Second order transfer functions may be seen in the mathematical expressions 1 through 3. In many cases, however, transfer functions having the order of 3 or more includes the second transfer function as a basic factor thereof. High order transfer functions may be approximated to the second order transfer function. Accordingly, vibration may be generally reduced by designing the natural frequency of the system to be less than the exciting frequency Ws.

When the developing roller 200 is rotated by driving of the gears, the exciting frequency may be represented as various values. For example, the exciting frequency may be a rotation frequency (assuming 40 Hz) of the developing roller 200, a frequency obtained by multiplying the rotation frequency by the number of teeth in the gear 230 (for example, 400 Hz when the number of teeth is 10), and a harmonic frequency corresponding to the integer times thereof due to digital signal processing. In most cases, the exciting frequency Ws is equivalent to the rotation frequency of the developing roller 200 if the gear train 230, 241, and 250 or the rotation axis 210 are provided properly. Otherwise, the exciting frequency Ws that has the biggest influence in generating jitter and vibration may be determined, such as through experimentation.

Referring to the mathematical expression 2, the natural frequency is proportional to the square root of the torsional elastic modulus K and inversely proportional to the square root of the mass moment of inertia J. The damping coefficient B is related only to the damping ratio ξ, and does not affect the natural frequency. It is not desirable to increase the mass moment of inertia in the driving system of the developing roller 200. Because the size and the mass of the system of the developing roller 200 are thereby increased, minimization cannot achieved and the driving load on the developing roller 200 is increased. The torsional elastic modulus K of the system of the developing roller 200, therefore, may be decreased to reduce the natural frequency. FIGS. 4A through 4 E show various exemplary embodiments for reducing the torsional elastic modulus K of the driving system of the developing roller 200. FIG. 5 shows an exemplary embodiment for substantially reducing the torsional elastic modulus of the gear 230. Reducing the torsional elastic modulus of at least one gear 230 among the gear train 230, 241, and 250, reduces the equivalent torsional elastic modulus with respect to the developing roller 200.

Referring to FIG. 7, before the vibration reducing member is prepared, the natural frequency Wn0 exists at the right side of the exciting frequency Ws, and the amplitude of the frequency response with respect to the exciting frequency Ws becomes A0, greater than 1. After the vibration reducing member is prepared, the natural frequency Wn1 exists at the left side of the exciting frequency Ws, and the amplitude of the frequency response with respect to the exciting frequency Ws becomes A1, less than 1. The vibration reducing member meets the two requirements that the natural frequency Wn1 exists at the left side with respect to the exciting frequency Ws, and the frequency Wk, which is defined as the frequency when the amplitude of the frequency response is 1, exists at the left side with respect to the exciting frequency Ws. When the two requirements are satisfied, vibration may be reduced. Throughout the various exemplary embodiments shown in FIGS. 4A through 5, a predetermined torsional elastic modulus is determined to meet the requirements.

FIG. 8 is a graph illustrating a damping operation of the vibration reducing member according to exemplary embodiments of the present invention. The x-axis represents frequency, whereas the y-axis represents the amplitude |m(jw)| of the normalized frequency response. The influence that the change in the damping ratio ξ has on the amplitude |m(jw)| of the frequency response when the natural frequency is a constant is shown in the graph in FIG. 8. Most systems are under-damped systems having the damping ratio less than 1. The damping ratio ξ in the rotation direction of the driving system of the developing roller 200 may be also seen to be less than 1. When the natural frequency is constant, the amplitude |m(jw)| of the frequency response may be reduced by increasing the damping ratio. Accordingly, in the vibration reducing member according to exemplary embodiments of the present invention, it is preferable to provide at least one of elastic and damping properties of the developing roller 200 in the rotation direction. Rubber, urethane or synthetic resin may be provided as a material having both elastic and damping properties.

FIGS. 4D and 4E are views of the visco-elastic bodies 221 and 222 providing elastic and damping properties to the driving system of the developing roller 200 according to an exemplary embodiment of the present invention. FIG. 5 is a view of the visco-elastic body 231 providing elastic and damping properties to at least one of the gears 230 among the gear train 230, 241, and 250 according to another exemplary embodiment of the present invention.

In the exemplary embodiments of the present invention, a phase difference occurs in the rotation angle of the developing roller 200. The maximum phase difference in the second order transfer function 7 is 180 degrees. Therefore, when the photosensitive member 130 contacts the developing roller 200 to form an electrostatic latent image, a developing nip is formed un-uniformly due to the phase difference, and thus it is not desirable to use the vibration reducing member of an exemplary embodiment of the present invention. In the exemplary embodiments of the present invention where the photosensitive member 130 and the developing roller 200 do not contact each other and developing is carried out in the developing gap, possible developing failure caused by the phase difference may be substantially prevented. This is because the development is carried out by a jumping of developing materials. In the image forming apparatus according to the exemplary embodiments of the present invention, the photosensitive member 130 is preferably separated from the developing roller 200 by a predetermined distance to form the developing gap, and the development operation is preferably carried out by the jumping of developing materials.

In the above description, a modeling of the driving system of the developing roller 200 has been performed, and the torsional elastic modulus and damping coefficient of the vibration reducing member has been determined by solving dynamic equations. Not to be limited thereto, the frequency response of the driving system of the developing roller 200 may be accurately obtained through real experiments by the use of a vibration hammer or a vibrator. The exciting frequency applied to the developing roller 200 may be also measured with a vibration sensor. The frequency response of the driving system of the developing roller 200 may be determined by the aid of various analysis methods through a computer simulation. Once the frequency response and the exciting frequency of the driving system of the developing roller 200 are determined, a series of processes that determine the torsional elastic modulus and the damping coefficient of the elastic body 220 and the visco-elastic bodies 221, 222, and 231 may be more readily and accurately carried out.

Accordingly, in the image forming apparatus according to exemplary embodiments of the present invention, shock or vibration generated at a driving system of a developing roller is not directly transferred to the developing roller but reduced, so that printing failure caused by a jitter may be substantially prevented and the quality of print image may be improved.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An image forming apparatus, comprising:
a photosensitive member on which an electrostatic latent image is formed;
a developing unit that develops the electrostatic latent image with developing materials and that includes a developing roller that rotates about a rotation axis thereof with the developing roller facing the photosensitive member; and
a vibration reducing member that reduces vibration of the developing roller.

2. The image forming apparatus according to claim 1, wherein
the vibration reducing member reduces the vibration in a rotation direction of the developing roller by changing the natural frequency in the rotation direction of the developing roller to be less than the exciting frequency in the rotation direction of the developing roller.

3. The image forming apparatus according to claim 2, wherein
the vibration reducing member reduces the equivalent torsional elastic modulus of the developing roller and includes an elastic body provided to at least one portion of the rotation axis.

4. The image forming apparatus according to claim 3, wherein
the elastic body is a coil shaped torsion spring that connects first and second portions of the rotation axis.

5. The image forming apparatus according to claim 3, wherein
the elastic body is a plate shaped torsion spring that connects first and second portions of the rotation axis.

6. The image forming apparatus according to claim 3, wherein
the elastic body is a flexible coupling that connects first and second portions of the rotation axis.

7. The image forming apparatus according to claim 2, wherein
the vibration reducing member reduces the equivalent torsional elastic modulus of the developing roller and provides damping characteristics and includes a visco-elastic body provided to at least one portion of the rotation axis.

8. The image forming apparatus according to claim 7, wherein
the visco-elastic body is made of at least one of rubber, urethane and synthetic resin.

9. The image forming apparatus according to claim 2, wherein the developing unit includes
a gear train for transferring driving force to the rotation axis, wherein the vibration reducing member reduces the equivalent torsional elastic modulus of the developing roller and provides damping characteristics and includes a visco-elastic body provided at teeth of at least one gear of the gear train.

10. The image forming apparatus according to claim 9, wherein
the visco-elastic body is made of at least one of rubber, urethane and synthetic resin.

11. The image forming apparatus according to claim 3, wherein the developing unit includes
a gear train for transferring driving force to the rotation axis, wherein the vibration reducing member reduces the equivalent torsional elastic modulus of the developing roller and provides damping characteristics and includes a visco-elastic body provided at teeth of at least one gear of the gear train.

12. The image forming apparatus according to claim 11, wherein
the visco-elastic body is made of at least one of rubber, urethane and synthetic resin.

13. The image forming apparatus according to claim 7, wherein the developing unit includes
a gear train for transferring driving force to the rotation axis, wherein the vibration reducing member reduces the equivalent torsional elastic modulus of the developing roller and provides damping characteristics and includes a visco-elastic body provided at teeth of at least one gear of the gear train.

14. The image forming apparatus according to claim 13, wherein
the visco-elastic body is made of at least one of rubber, urethane and synthetic resin.

15. The image forming apparatus according to claim 2, wherein
the vibration reducing member reduces the equivalent torsional elastic modulus of the developing roller and provides damping characteristics and includes
an elastic body disposed between first and second portions of the rotation axis; and
a first visco-elastic body disposed between second and third portions of the rotation axis.

16. The image forming apparatus according to claim 15, wherein the developing unit includes
a gear train for transferring driving force to the rotation axis, wherein the vibration reducing member reduces the equivalent torsional elastic modulus of the developing roller and provides damping characteristics and includes a second visco-elastic body provided at teeth of at least one gear of the gear train.

17. The image forming apparatus according to claim 16, wherein
the first and second visco-elastic bodies are made of at least one of rubber, urethane and synthetic resin.

18. The image forming apparatus according to claim 15, wherein
the elastic body is a coil shaped torsion spring.

19. The image forming apparatus according to claim 15, wherein
the elastic body is a plate shaped torsion spring.

20. The image forming apparatus according to claim 15, wherein
the elastic body is a flexible coupling.

21. A developing unit for an image forming apparatus, comprising:
a developing roller having a rotation axis;
a power supply supplying power to rotate the developing roller; and
a vibration reducing member connected between the developing roller and the power supply to reduce vibration of the developing roller.

22. A developing unit according to claim 21, wherein
the vibration reducing member reduces vibration in a rotation direction of the developing roller.

23. A developing unit according to claim 22, wherein
the vibration reducing member reduces the vibration in the rotation direction of the developing roller by changing the natural frequency in the rotation direction of the developing roller to be less than the exciting frequency in the rotation direction of the developing roller.

24. A developing unit according to claim 21, wherein
the vibration reducing member reduces the equivalent torsional elastic modulus of the developing roller and includes an elastic body provided to at least one portion of the rotation axis.

25. A developing unit according to claim 24, wherein
the elastic body is a coil shaped torsion spring that connects first and second portions of the rotation axis.

26. A developing unit according to claim 24, wherein
the elastic body is a plate shaped torsion spring that connects first and second portions of the rotation axis.

27. A developing unit according to claim 24, wherein
the elastic body is a flexible coupling that connects first and second portions of the rotation axis.

28. A developing unit according to claim 23, wherein
the vibration reducing member reduces the equivalent torsional elastic modulus of the developing roller and provides damping characteristics and includes a visco-elastic body provided to at least one portion of the rotation axis.

29. A developing unit according to claim 28, wherein
the visco-elastic body is made of at least one of rubber, urethane and synthetic resin.

30. A developing unit according to claim 23, wherein
a gear train transfers driving force from the power supply to the rotation axis; and
the vibration reducing member reduces the equivalent torsional elastic modulus of the developing roller and provides damping characteristics and includes a visco-elastic body provided at teeth of at least one gear of the gear train.

31. A developing unit according to claim 30, wherein
the visco-elastic body is made of at least one of rubber, urethane and synthetic resin.
